(19) United States
(12) Patent Application Publication
(10) Pub. No.: US 2004/0019506 A1
(43) Pub. Date: Jan. 29, 2004

(54) Method and system for generating endowment for a tax-exempt organization

(76) Inventors: Brian P. Struchtemeyer, Columbia, MO (US); Ralph E. Struchtemeyer, Hartsburg, MO (US); Melissa K. Struchtemeyer, Hartsburg, MO (US)

Correspondence Address: LEYDIG VOIT & MAYER, LTD, TWO PRUDENTIAL PLAZA, SUITE 4900, 180 NORTH STETSON AVENUE, CHICAGO, IL, 60601-6780, US

(21) Appl. No.: 10/201,421

(22) Filed: Jul. 23, 2002

(51) Int. Cl. G06F 17/60

(52) U.S. Cl. 705/4

(57) ABSTRACT

A program for generating new endowment for a tax-exempt organization. Life insurance policies are purchased for a group of suitable donor individuals, with the tax-exempt organization as the beneficiary. A finance company lends money to the tax-exempt organization in amounts sufficient to pay the annual life insurance premiums, and a secondary bank lends further money to the tax-exempt organization to cover the interest that accumulates annually on the premium loans. Upon the death of a donor individual, the policy death benefit is used in several ways: a predetermined fixed amount is set aside and used to pay the interest loan; a predetermined priority portion of the remainder is used to pay the premium loans; and, after the premium loans have been paid in full, any remaining balance is accumulated as new endowment. A Monte Carlo simulation is used to predict the program's performance.

### TECHNICAL FIELD

The present invention relates generally to endowments of tax-exempt organizations and, more particularly, to a method and system for generating endowment by insuring the lives of donor individuals on behalf of a tax-exempt organization.

### BACKGROUND OF THE INVENTION

A tax-exempt organization (such as a charitable organization, not-for-profit group, etc.) requires capital to fund the performance of its desired mission and related community functions, as well as to pay its day-to-day operating expenses. While some of this capital is obtained from governmental entities and corporate benefactors, much of it comes through donations from individuals who are interested in ensuring the continued existence and work of the organization. Historically, the quantity and size of such individual donations in a given annual period has tended to vary based upon the general state of the economy and/or the individual donors' personal circumstances, with the result being that the influx of working capital (and thus the size of the organization's endowment) can be somewhat uncertain.

In an effort to more consistently grow (or at least stabilize) the annual influx of working capital and the size of their endowments, tax-exempt organizations have sought and developed various programs designed particularly to encourage individual donations, regardless of prevailing economic or individual circumstances. For example, life insurance has been considered and used as a tool for generating endowment for tax-exempt organizations, but so far such programs have been unsuccessful due to various design flaws, including the requirement of excessive out-of-pocket expenses and/or collateral on the part of the tax-exempt organization.

What has been needed is a method and system that reliably generates endowment for the tax-exempt organization, particularly from individual donors, without unduly utilizing the existing assets (capital or otherwise) of the organization.

### BRIEF SUMMARY OF THE INVENTION

The above problems and shortcomings, and others, are addressed by the present invention, which can be understood by referring to the specification, drawings and claims.

According to the present invention, a tax-exempt organization, working with other participants, establishes a program for generating new endowment for itself through individual donors. A group of suitable donor individuals is identified and a life insurance policy (having an annual premium and a death benefit amount) is purchased for each of the donor individuals, with the tax-exempt organization being the owner and beneficiary of the policies. To avoid a significant outlay of its own assets, the tax-exempt organization obtains a loan from a finance company sufficient in amount to pay the annual premiums cumulatively due for the life insurance policies. Interest accumulates annually on this premium loan and must be paid in full each year. The tax-exempt organization can pay this interest directly if it has sufficient endowment or other assets or a secondary loan can be obtained to cover the interest payment. In the latter case, secondary interest accumulates on the interest loan and thus creates an interest loan balance.

Upon the death of a donor individual, the death benefit from the individual's life insurance policy is used in several ways. In those situations when a secondary interest loan was obtained by the tax-exempt organization, a predetermined fixed amount of the death benefit (for example, $75,000) first is set aside and used to pay down the interest loan balance. If the cumulative set-asides from the death benefits paid out during a year are insufficient to cover the entire interest loan balance, the tax-exempt organization must pay the rest of this loan out-of-pocket. After the set-aside for paying the interest loan, a predetermined priority portion of any remaining death benefit (for example, one hundred percent of the remainder) is used to pay down the premium loan. Should the remaining death benefit amount exceed the balance of the premium loan, the death benefit portion in excess of the premium loan is accumulated as new endowment of the tax-exempt organization. Over a period of years, as more and more of the donor individuals die, out-of-pocket expenses dwindle and the new endowment of the tax-exempt organization grows.

Often, as part of the overall program, a Monte Carlo simulation will be used at the start to test the program's variables in order to find an appropriate implementation and predict the program's performance for all parties involved. For example, the simulation can be used to predict anticipated growth of new endowment for the tax-exempt organization, thereby encouraging the organization to initiate and follow through with the program.

### BRIEF DESCRIPTION OF THE DRAWINGS

While the appended claims set forth the features of the present invention with particularity, the invention, together with its objects and advantages, may be best understood from the following detailed description taken in conjunction with the accompanying drawings, of which:

FIG. 1a is a schematic diagram showing certain interactions between participants in the program of the present invention, including the purchase of life insurance policies and the financing of the insurance premiums;

FIG. 1b is another schematic diagram showing further interactions between program participants, including collateral assignments and obtaining an interest loan and paying interest on the premium loan;

FIG. 1c is another schematic diagram showing still further interactions between program participants, particularly the use of death benefits from the life insurance policies;

FIG. 2a is a graph illustrating an example of average expected reinvested endowment value accumulated over time for the program of the present invention;

FIG. 2b is a graph illustrating an example of predicted out-of-pocket costs over time for the program of the present invention;

FIG. 3 is a flowchart of an exemplary method of performing a Monte Carlo simulation for predicting average results, including endowment growth results, generated by the inventive program;

FIG. 3a is a flowchart of an exemplary method for randomly testing the mortality of donor individuals in the Monte Carlo simulation of FIG. 3;

FIGS. 3b-3d are flowcharts showing an exemplary method for analyzing annual endowment growth in the Monte Carlo simulation of FIG. 3;

FIG. 3e is a flowchart of an exemplary method for analyzing the total results of an iteration of the Monte Carlo simulation of FIG. 3; and

FIG. 3f is a flowchart of an exemplary method for calculating the average predicted endowment growth in the Monte Carlo simulation of FIG. 3.

### DETAILED DESCRIPTION OF THE INVENTION

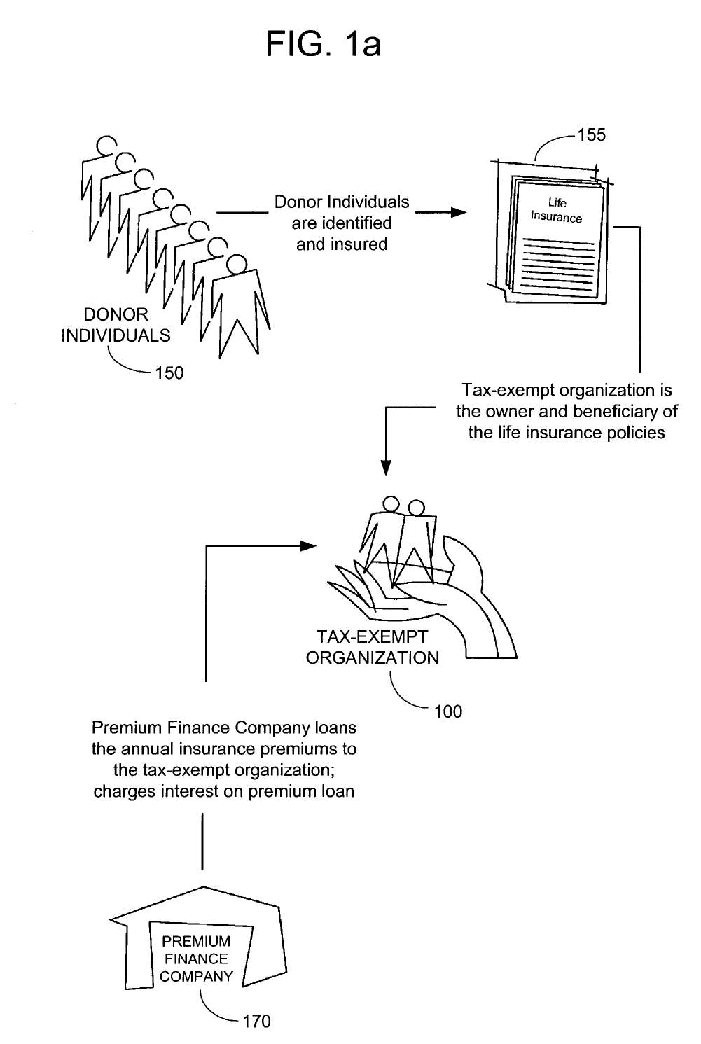

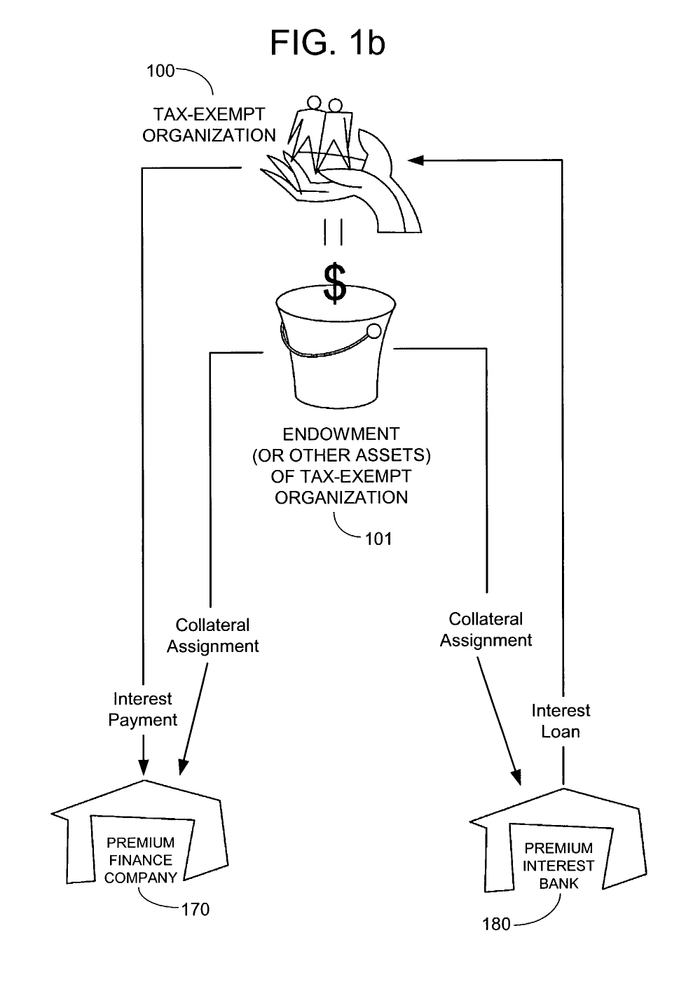

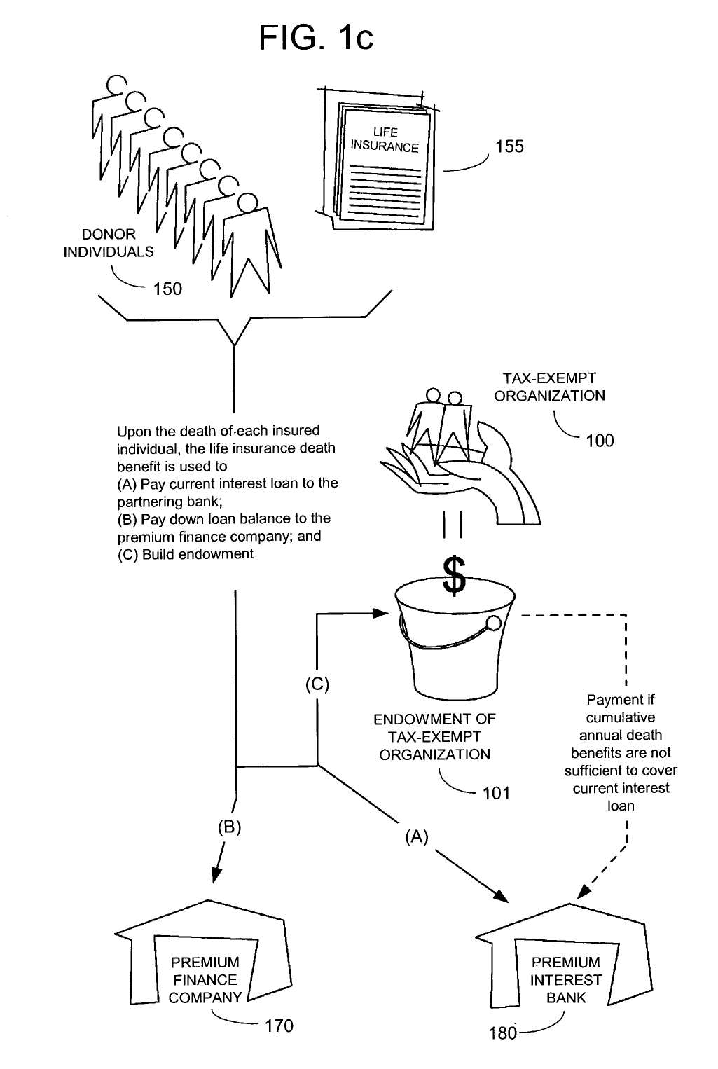

The following description is based on embodiments of the invention and should not be taken as limiting the invention with regard to alternative embodiments that are not explicitly described herein. Turning now to the drawings, wherein like reference numerals refer to like elements, and referring first to FIGS. 1a-1c, there is shown schematically participants in the system and method of the present invention (referred to by the assignee of this application as the Partners In Philanthropy™ program) and at least some of their respective interactions with one another.

The program provides a very effective, low cost means for generating unrestricted endowment and operational cash flow for an organization that qualifies for tax-exempt status under section 501(c)(3) of the United States Tax Code. Pursuant to the program, as shown in FIG. 1a, the tax-exempt organization 100 identifies a group of individuals who believe in the mission of the organization and wish to help secure its future. These persons are screened to verify whether they meet certain criteria that are critical to the success of the program. Specifically, ideal individuals should generally be in the range of 70-75 years of age and, with respect to life insurance, they should not be table rated—due to their particular health, occupation or avocation—at either a much higher or much lower premium cost. A minimum of fifty people that meet these criteria is necessary to form a viable group (the donor individuals 150) to support the program, but a larger group can be used. A group of fifty donor individuals has been found to be preferred because it is large enough for statistically normal group dynamics and to provide a significant program return, yet a group that size will not require either collateral costs or out-of-pocket costs that are too large for the typical tax-exempt organization.

A life insurance policy 155 is purchased for each of the donor individuals 150, with the tax-exempt organization 100 being designated the owner and beneficiary. Each life insurance policy 155 has an associated annual premium, cash surrender value and death benefit. This insurance policy may comprise a mix of term, universal and Return of Premium rider insurance, where the ratio of these components is set to maximize benefits for the premium cost while maintaining an appropriate balance in the policy cash surrender value (for example, at least a balance sufficient to support the collateral needs for the program loans). The total amount of benefits for each policy depends upon the program size selected by the tax-exempt organization 100, the starting age of the respective donor individual, and the actuarially-projected length of time that donor individual will be in the program. The face amount of the insurance coverage should be identical for each donor individual in the group, which means that the death benefit and the premium amount will be identical for each donor individual of the same start age (e.g., for each person starting at age 72). Selection of the size of the face death benefit for the donor individuals in the program typically will be based upon the tax-exempt organization's ability to collateralize the necessary notes and maintain the liquidity required for necessary loans. For example, a smaller program might have a face death benefit of $50,000 per donor individual, while a large program might have a face death benefit of $125,000 per donor individual. It has been determined that a preferred life insurance policy will have a twenty-year level payment with an increasing benefit amount, and a significant portion of any excess cash value in the policy may be used to purchase additional term coverage to enhance the total death benefit.

Rather than having the tax-exempt organization pay the annual insurance premiums for the policies out of its assets, a premium loan is arranged. More specifically, a premium finance company 170 loans an amount equal to the cumulative annual insurance premiums for the surviving donor individuals to the tax-exempt organization 100. Interest, which is payable at the beginning of each year, accumulates on this premium loan, creating a premium loan balance. This interest likely will accumulate at a rate within the range of 6-9 percent annually (based upon noted actual rates from 1989 to 2000).

The tax-exempt organization 100 can directly pay the annual interest due to the premium finance company 170 if it has adequate liquid assets to do so. But most tax-exempt organizations lack the financial flexibility needed to pay the required interest up-front and out-of-pocket. Thus, to facilitate the timing difference between the up-front interest due to the premium finance company 170 and the receipt of policy benefits upon the death of donor individuals, a secondary bank loan may be used (see FIG. 1b). In those circumstances, the tax-exempt organization 100 obtains an interest loan (potentially during each year of the program) from a secondary financing entity (i.e., premium interest bank 180) in an amount sufficient to cover the annual interest that has accumulated on the loan from the premium finance company 170. As will be appreciated, the tax-exempt organization then uses this loan to pay for the annual interest that has accumulated on the premium loan.

To secure this secondary interest loan (structured as a one-year working capital loan), as well as the premium loan, the tax-exempt organization 100 executes collateral assignments on each life insurance policy in favor of the premium finance company 170 and the premium interest bank 180. Typically, a collateral pledge on some portion of the tax-exempt organization's assets 101 (such as the endowment) will be necessary during the first few years of the program. The assets used for collateral generally will be released when the cumulative cash surrender value of the life insurance policies 155 equals 100-110 percent of the total premium loan balance. At that point, the cash surrender value of the policies provides the full collateral to both the premium finance company 170 and the secondary premium finance bank 180. If the tax-exempt organization lacks the necessary assets at the start of the program to provide sufficient collateral, it can use a letter of credit or other pledge from outside sources (such as a donor, a corporation or a foundation) as collateral. Importantly, these assets are only pledged as collateral; the income from these assets is still available to the tax-exempt organization or to the person, company or foundation providing the capital.

As with the premium finance loan, interest accumulates on the secondary loan from the premium interest bank 180. Historically (based upon actual rates observed from 1989 through 2000), the interest charged on such loans will range from 6-9 percent annually.

FIG. 1c shows a preferred plan for distributing the life insurance death benefits. Upon the death of an insured donor individual 150, the benefits from his/her respective life insurance policy 155 are allocated in a specific manner, depending upon the magnitude of the insurance program. A first priority is to pay current interest to the premium interest bank 180 on the working capital loan in order to somewhat minimize the tax-exempt organization's out-of-pocket costs. A second, and overall more significant, priority is to pay down the premium loan from the premium finance company 170, since the premium loan balance is the principal cost driver for all interest. Finally, residual death benefits accrue to a new endowment fund 101 for the tax-exempt organization 100. The interest loan from the premium interest bank 180 is one priority since banking regulators in the United States do not allow long-term lending of interest. Thus, at the end of each annual period, the tax-exempt organization 100 is required to repay in full the secondary interest loan balance (including all interest accumulated on it), irrespective of the amount of life insurance death benefits received during that year. If an insufficient amount of death benefits are received during any one-year loan period, the tax-exempt organization must use other funds (such as money accumulated in the endowment 101) to repay the secondary bank note from the premium interest bank 180.

According to a preferred approach for administering the program, a predetermined fixed amount (for example, $75,000) of the death benefit derived from each life insurance policy is set aside for use, if needed, to pay down the interest loan balance due to the premium interest bank 180. If any further death benefit amount remains from that life insurance policy, then a predetermined priority portion of that leftover is used to pay down the loan from the premium finance company 170. Preferably, until the premium loan balance is reduced to zero, one hundred percent of this leftover portion is used for the purpose of paying down the premium loan balance. Likewise, in situations where there is no secondary interest loan (such as where the tax-exempt organization 100 has paid the interest on the premium loan out of its own assets) it is desirable that one hundred percent of the death benefit from each life insurance policy be used to pay down the premium loan balance until that balance is zero.

If any death benefit from a life insurance policy remains after deducting the predetermined fixed amount for paying down the interest loan balance and after deducting the predetermined portion for paying down the premium loan balance, that remainder is accumulated in the new endowment 101 of the tax-exempt organization 100. Typically, the money accumulated in the endowment 101 will be invested in some low risk manner that historically has provided an annual investment return in the range of 4.5-7.5 percent.

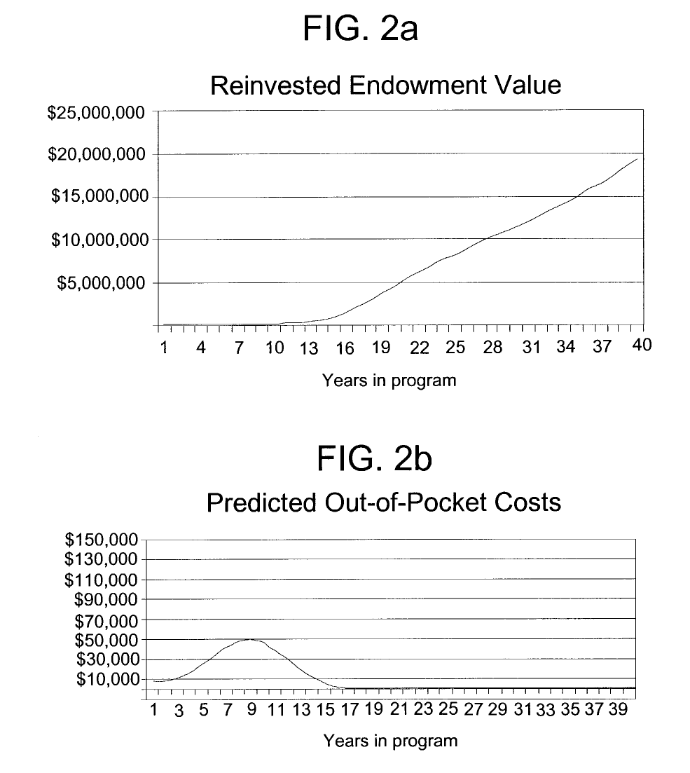

The net effect is to build substantial endowment for the tax-exempt organization over the established term of the program (preferably 40 years in view of the desired start ages of the donor individuals). FIG. 2a is a cumulative graph showing expected average case results for a small program under current market conditions (i.e., a program with life insurance policies each having a $50,000 face value). As can be seen from this graph, currently the program might reasonably be expected to accumulate for the tax-exempt organization a reinvested endowment value of nearly $20 million over a forty-year period, although growth of the endowment likely will be minimal for about the first ten years.

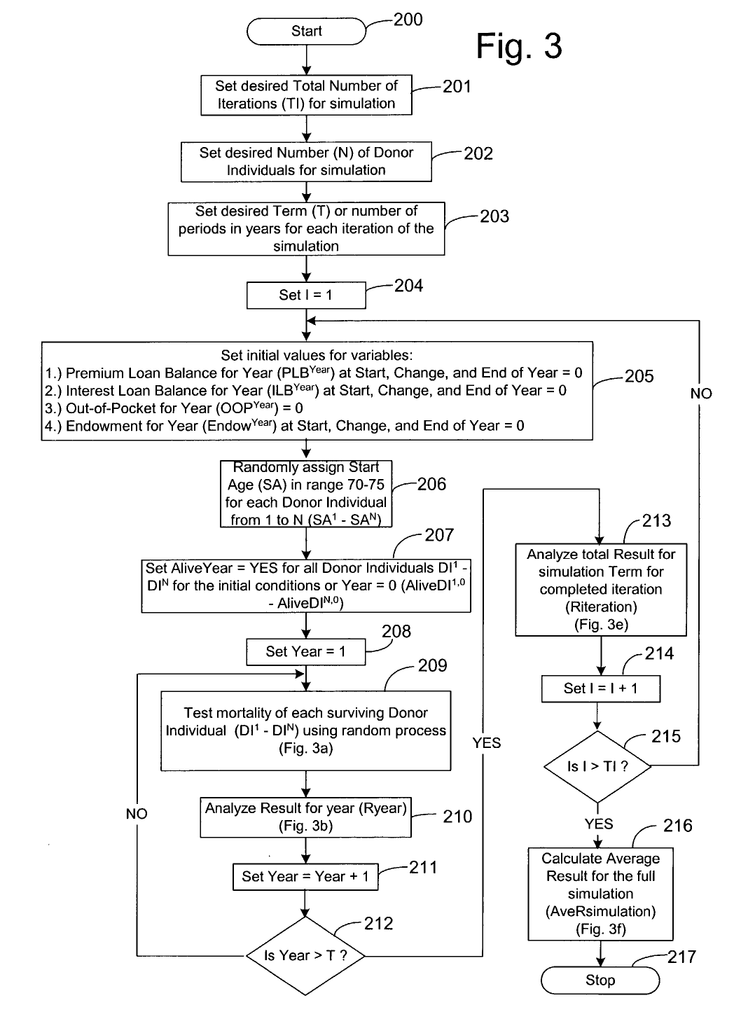

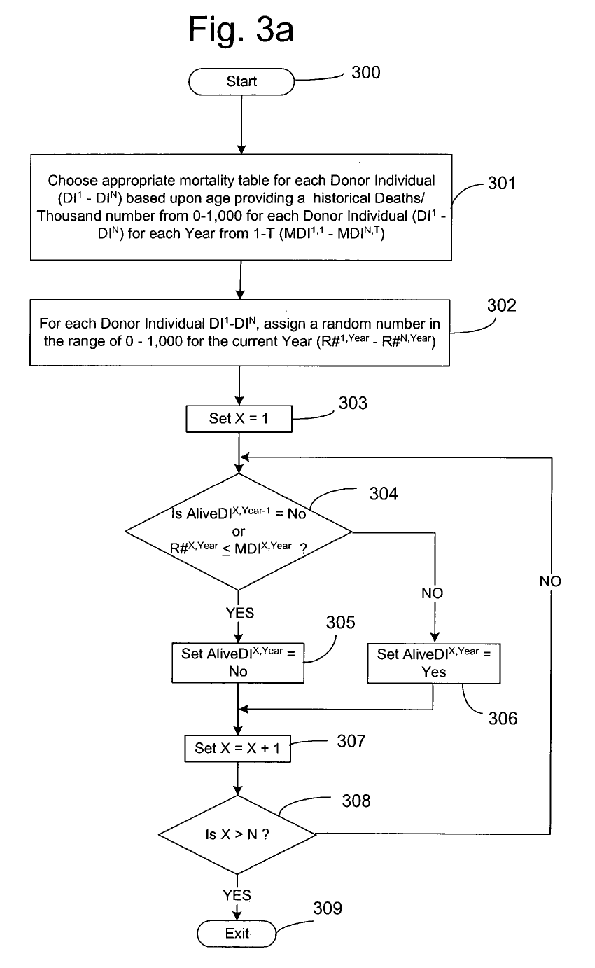

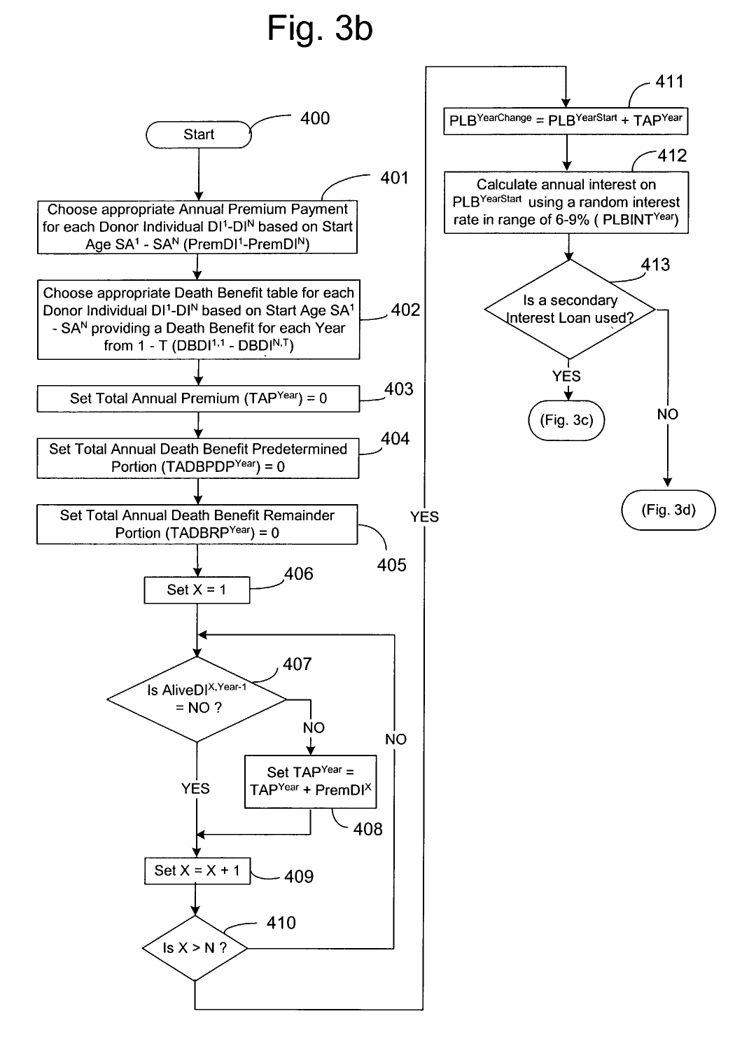

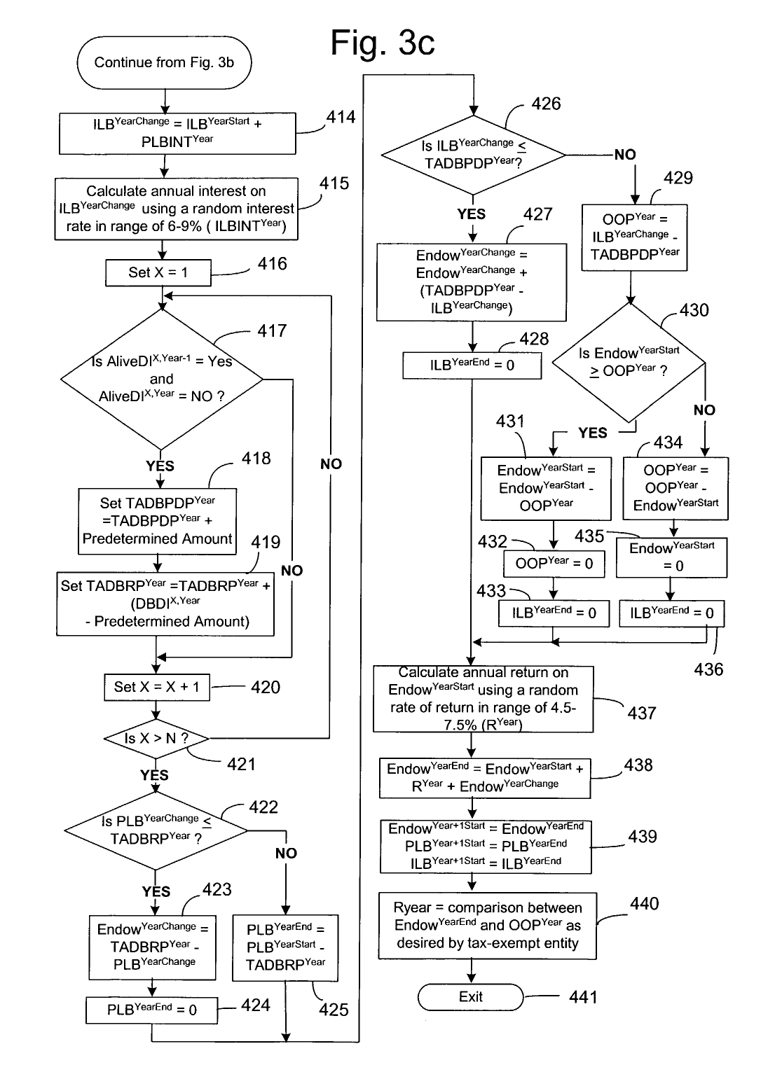

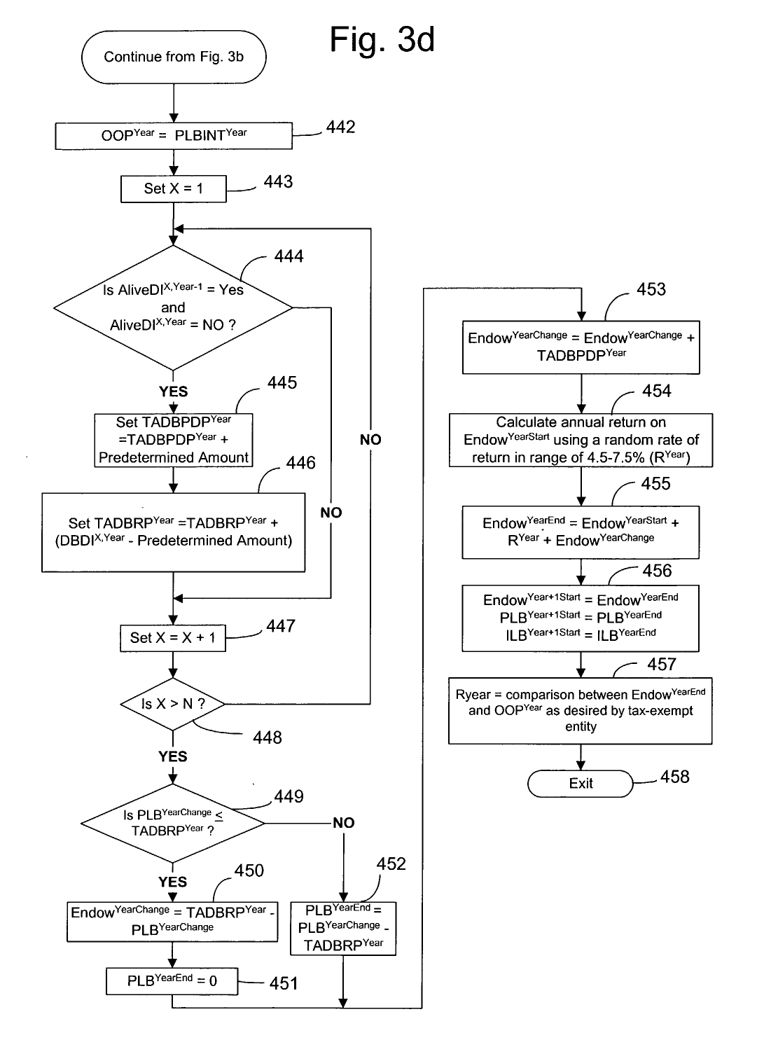

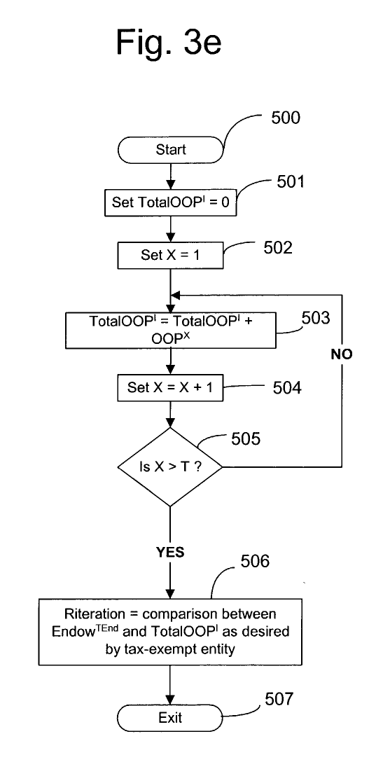

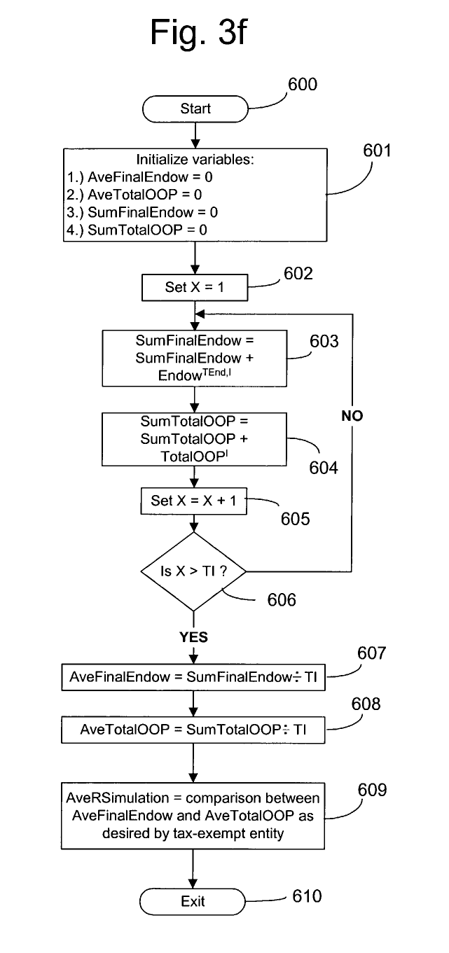

It is expected that the tax-exempt organization 100 will incur various out-of-pocket expenses in connection with the program, particularly during the early years when there may be few deaths of donor individuals and, therefore, minimal death benefit proceeds. FIG. 2b illustrates average predicted out-of-pocket costs over the term of the program under current market conditions. As shown, if the death rates of the donor individuals 150 follow expected norms, there will be some material out-of-pocket expenses during the first fifteen or so years of the program (peaking around years 7-10), but dropping to zero after about years 17 or 18. The predicted results shown in FIG. 2b, as well as those shown in FIG. 2a, were calculated by the inventors using a Monte Carlo simulation of the program, which will be discussed in further detail below in connection with FIGS. 3-3f.

As will be appreciated, the program can be established and coordinated on behalf of the tax-exempt organization 100 by the company providing the life insurance policies 155, by the premium finance company 170, by the premium interest bank 180 or by another independent person or company (not shown in FIGS. 1a-1c). Other than the initial identification of the group of interested persons from which the donor individuals 150 will be selected, this coordinating entity can assist the tax-exempt organization 100 with any or all of the program tasks—for example, properly insuring the donor individuals, obtaining the premium and interest loans, processing life insurance claims, utilizing the death benefits from the policies to lawfully and efficiently pay down the premium and interest loans and accumulate endowment, and investing the endowment funds. If desired, this entity can also provide a Monte Carlo simulation of the program for any of the parties involved, including the tax-exempt organization.

Alternatively, in accordance with another aspect of the invention, there can be provided a computer-readable CD-ROM or diskette (or even a website) having software that includes the necessary information, guidelines and instructions for establishing and running the program to generate endowment for the tax-exempt organization. For example, this software can explain, among other things, how to identify appropriate donor individuals, guidelines (particularly regarding premiums and death benefit amounts) for purchasing appropriate life insurance policies, guidelines for obtaining premium loans and/or interest loans, proposals for using the death benefit proceeds most effectively (and within legal regulations), and proposals for investing any money that accumulates in the endowment.

This software can also include code for running a Monte Carlo simulation of the endowment-generating program, using data that is input regarding premium rates, interest rate ranges, death benefit amounts, return on investment rate ranges, etc.

In accordance with another aspect of the invention, a Monte Carlo simulation has been developed that can be used to predict results of the program to any or all of the participants. In general, this simulation model is used to verify the performance characteristics and overall financial stability of the program. In this simulation, elements of the program that can vary or change between tax-exempt organizations or between years for the same group are selected randomly within a relevant range. The results from computations using these randomly selected variables are collected and this process is repeated for 10,000 iterations to be considered valid. This body of data is ultimately studied using well-known statistical methods to determine the average expected outcomes of the program, along with various best and worse case scenarios. Because the variables of each sample are randomly selected and the total sample size is large enough, it is considered appropriate to treat the descriptive statistics for the simulation output as inferential in predicting the expected outcomes of actual participating groups in real life.

With regard to the program, the most critical element is the rate and timing at which donor individuals die. The simplest assumption for death rates would be those found on the Commissioner's Standard Ordinary (CSO) tables. However, those death rates are listed as the ratio of deaths per 1000 people. Because each specific group for the program of the present invention contains a minimum of 50 donor individuals (and is highly unlikely to ever include a number close to 1000), directly assuming the listed CSO death rates is inappropriate. Given the much smaller group size, it is realistic to expect that any specific group's experience will be somewhat different than the overall average. This is especially critical when considering gaps or years in which no donor individuals pass away.

The following modeling method was developed to use the historically accurate CSO tables as a guideline, yet allow the random Monte Carlo process to show the inevitable variations within different groups. The CSO tables were treated as a probability function of 1000 known outcomes. Specifically, the 1998 Male table was used as the starting point, as this was recent and most closely fit the pattern of donor individual participation observed thus far. The computer model selects a random number between 0 and 1000 for each donor individual participating in a tax-exempt organization's group, for every year of the program's lifespan. If the random number selected for a donor individual is less than or equal to the number of historical deaths per 1000 in the table, the computer treats that individual as having died during that year. In accordance with the standard treatment on CSO tables, the maximum life expectancy obtainable in this model is 100. The final results of this simulation method show variations between groups critical for a robust analysis that allows for the uncertainties of life, yet over the entire set of output is virtually identical to the CSO predictions based on measured historical experience.

To develop best and worst case scenarios from the perspective of the participating tax-exempt organization, the CSO tables used for the average case are adjusted to target an average death age of ±3.5 years. This maintains a consistent distribution, while allowing a longer or shorter average lifespan. For the worst case, donor individuals live longer on average, pushing out the length of time the tax-exempt organization must wait for policy benefits, increasing interest and other out-of-pocket costs in the interim. On the opposite end of the spectrum, the best case scenario has donor individuals dying sooner, decreasing the overall program costs and providing benefits to the tax-exempt organization more quickly.

Because three different assumptions of death rates were used in the development of the generally predicted scenarios, the mean average of those scenarios was used as the listed output. The computer model generates outputs both better and worse than the mean in each situation, but under the general principle of letting the assumptions drive the analysis, it seems most appropriate to use the general or mean average of each scenario as the predicted outcome. Of course, depending upon the concerns of any particular tax-exempt organization, the specific best and worst outputs can be used as predictors.

A second critical performance factor of the program that is utilized in the Monte Carlo simulation is the rate at which the premium loan from the premium finance company 170 is repaid. Under a secondary bank loan structure (i.e., where a secondary interest loan is obtained from a premium interest bank 180), special consideration is given to the allocation of policy death benefits in years where deaths occur. A predetermined portion of the death benefits are set aside for current interest and principal payment to the secondary bank 180. The bulk of the benefits are used for repayment of the premium loan, since all other costs, and ultimately the program's overall return, is derived from this loan. While this allocation can result in higher out-of-pocket costs, it more importantly minimizes the overall cost of the program, greatly reduces the risk of a participating tax-exempt organization losing money and enhances the resulting endowment size.

In a preferred embodiment of the program, of the total amount of policy benefits received for each deceased donor individual, $75,000 is set aside for use towards paying the secondary bank interest loans. Any excess of these benefits over the needs for the secondary bank notes are set aside in the new endowment the program builds. If insufficient benefits are received to repay that year's secondary bank note, any funds in the new endowment are applied to that bank note. Only after those funds are depleted is out-of-pocket money required. The net remainder of the policy benefits are used to pay down the loan balance from the premium finance company 170. Once the premium loan is paid in full, the entire amount of policy benefits are applied to the secondary bank notes and any remainder is used to build the new endowment.

Turning now to FIG. 3, there is shown a flowchart of an exemplary method of performing a Monte Carlo simulation for predicting average endowment growth results generated by the inventive program. At the start, the desired total number or iterations (TI), the desired number (N) of donor individuals, and the desired term (T) or number of periods in years for each iteration are set for the simulation (steps 201-203). Next, an iteration counter I is set to 1 (step 204), and several variable registers, including those for storing the premium loan balance for the current year, the interest loan balance for the current year and the endowment for the current year (each of which has separate values for the start, change and end of the year) and for storing the out-of-pocket costs for the current year, are set to 0 (step 205). At step 206, a start age in the range of 70-75 is randomly assigned for each of the simulation's donor individuals. Next (step 207), mortality files—called AliveDI—used to track whether the donor individuals remain alive are all set to “Yes” for the initial conditions (i.e., Year=0).

A year counter (Year) is set to 1 at step 208, and then (at step 209) the mortality of each surviving donor individual is tested using a random process that is shown in greater detail in the flowchart of FIG. 3a. Turning to FIG. 3a, the mortality test starts with an appropriate CSO mortality table being chosen for each donor individual based upon their current age (step 301). These tables provide a historical deaths-per-thousand number (ranging from 0-1000) for each donor individual for each year (1 through T) during the current iteration of the simulation. At step 302, each donor individual is assigned a random number in the range of 0-1000 for the current year. Next (step 303), a counter X is set to 1, and then (at step 304) an inquiry is made regarding whether the mortality file (AliveDI) for donor individual 1 says “No” or whether the random number assigned to donor individual 1 for the current year (R#^{1,1}) is less than or equal to the historical number (MDI^{1,1}) provided by the mortality table in step 301 for donor individual 1 for the current year. If either part of that inquiry is answered “Yes”, the computer interprets that to mean that the donor individual 1 has previously died or died during the current year and sets the mortality file for that donor individual to “No” (step 305). On the other hand, if the answer to both queries is “No”, then the computer interprets that to mean that donor individual 1 is still alive and sets the respective mortality file to “Yes” (step 306). At step 307, the counter X is incremented by 1, and at step 308 a check is made whether the incremented value of the counter X is greater than the set value specifying the number (N) of donor individuals for the simulation. If the answer is “No”, which means that the mortality of each donor individual in the simulation has not yet been checked, the program reverts to step 304 and checks the mortality of the next donor individual. If the answer at step 308 is “Yes”, then the mortality of each donor individual has been checked for the current year and the mortality test program sequence exits (i.e., returns to step 209 of FIG. 3).

Turning back to FIG. 3, the result (Ryear) for the current year of the simulated program is analyzed at step 210. The details of an embodiment of this analysis are shown in the flowchart diagrams of FIGS. 3b-3d, discussed further below. Next (step 211), the Year counter for the current iteration is incremented by 1, and at step 212 a query is made whether the incremented Year counter exceeds the set term (T) for the iteration. If not, the simulation sequence reverts to step 209 and begins to test the mortality of the surviving donor individuals for the next year of the current iteration, and then analyzes the result for the next year at step 210. As will be appreciated, steps 209-212 are repeated until a result analysis has been performed for each year in the desired term (for example, 40 years) of the current iteration.

Turning next to FIG. 3b, there is shown a flowchart illustrating the sequence of steps followed by the Monte Carlo simulation in analyzing results for the current year of an iteration of the simulated program. At the beginning of this analysis, an appropriate annual premium payment (PremDI) is chosen for each donor individual, based upon their start age, using data provided by an insurance company (step 401). And at step 402, an appropriate death benefit table is chosen for each donor individual, based upon their start age, which provides a death benefit amount for each year of the simulated program. These death benefit tables also are provided by the insurance company.

Next (steps 403-405), registers for storing the values of the total annual premium (TAP), the total annual death benefit predetermined portion (TADBPDP), and the total annual death benefit remainder portion (TADBRP) are all set to 0. At step 406, a counter X is set to 1, and at step 407 a query is made whether the mortality file for donor individual 1 for the previous year (Year-1) said “No”. If the answer to this query is “Yes”, it means that the donor individual died during some previous year. Accordingly, there will be no annual insurance premium for that donor individual during the current year, so the total annual premium register does not need to be incremented. The analysis sequence merely moves on to step 409, where the counter X is incremented by 1. On the other hand, if the answer at step 407 is “No”, the value in the register for total annual premium for the current year is incremented (at step 408) by the amount of the annual premium payment that was attributed in step 401 to the particular surviving donor individual. Next (step 409), the counter X is incremented by 1, and at step 410 this incremented counter value is compared to the designated number (N) of donor individuals for the simulation. If the value of counter X does not exceed the number of donor individuals, then the analysis sequence reverts to step 407 and checks the mortality file for the next donor individual. By means of this group of looping steps 407-410, a total annual premium value for the current year (TAP^{Year}) is determined for all donor individuals surviving at the start of the current year.

Once the total annual premium amount has been calculated for the year for all surviving donor individuals in the simulation (i.e., when the answer to the inquiry at step 410 is “Yes”), at step 411 the value in the register storing the change in premium loan balance for the current year (PLB^{YearChange}) is set to equal the sum of the total annual premium for the year and the premium loan balance at the start of the current year. An interest rate for the premium loan balance (in the range of 6-9 percent) is randomly selected, and annual interest on the premium loan balance at the start of the year is calculated using this interest rate (step 412). Next (step 413), a query is made whether a secondary interest loan is being used. If the answer to this inquiry is “Yes”, the analysis follows the flowchart of FIG. 3c. On the other hand, if there is no secondary interest loan, the analysis follows the flowchart of FIG. 3d.

First turning to FIG. 3c (when there is a secondary interest loan), at step 414 the value stored in the register for the change in the interest loan balance for the current year (ILB^{YearChange}) is set to equal the sum of the interest loan balance at the start of the year and the annual interest that was previously calculated at step 412 on the premium loan balance for the year. Annual interest on the interest loan balance next is calculated (step 415) using a random interest rate in the range of 6-9 percent. It will be appreciated that the 6-9 percent range of interest rates used in step 415 (as well as in step 412) was selected based upon historically relevant data collected over the past 20 years. If this historically relevant range changes in the future, the program should be modified to use the new relevant range in each of steps 412 and 415.

A counter X is set to 1 at step 416, and then a dual inquiry is made (step 417) regarding whether the mortality file for donor individual 1 for the previous year says “Yes” and whether the mortality file for that same donor individual for the current year says “No”. If the answer to this dual inquiry is “Yes”, which means the donor individual died during the current year, then the register storing a value for the predetermined portion of the total annual death benefit for the current year is incremented by an amount equal to the predetermined fixed portion of each death benefit that the tax-exempt organization has decided to set aside for the purpose of paying down the interest loan from the premium interest bank. As discussed previously, a preferred fixed set-aside amount for this purpose is $75,000. If, for example a $75,000 amount is predetermined by the tax-exempt organization, then at step 418 the value stored in the register for the predetermined portion of the total annual death benefit will be incremented by $75,000 each time it is determined that a donor individual has died during the current year. Next (step 419), the register storing the value for the remainder portion of the total annual death benefit for the current year is incremented by an amount equal to the difference between the total death benefit for the deceased donor individual (determined at step 402 of FIG. 3b) and the predetermined fixed set-aside amount. This register shows how much additional death benefit remains to be used for purposes other than paying the interest loans.

If, on the other hand, the answer to either of the inquiries at step 417 is “No”, which means that the particular donor individual either remained alive during the current year or was already deceased at the start of the current year, then the tax-exempt organization does not receive any death benefit for that donor individual during the current year and steps 418 and 419 of the sequence are skipped. The counter X is incremented by 1 (step 420), and at step 421 this incremented counter value is compared to the total number of donor individuals specified for the simulation. If the incremented counter value does not exceed the total number of donor individuals specified, the analysis sequence reverts to step 417 and determines whether the next donor individual has died during the current year. It will be appreciated that the looping group of steps 417-421 ensures that all of the donor individuals are checked, that account is made of the death benefits derived from any of them that have died during the current year, and that a donor individual is not credited with a death benefit more than once.

Once all of the donor individuals have been checked for the current year (i.e., when the answer to the inquiry at step 421 is “Yes”), the analysis sequence proceeds to step 422 where a query is made whether the value stored in the register for the current year's change in the premium loan balance is less than or equal to the value stored in the register for the remainder portion of the total annual death benefit for the current year. If the answer to this inquiry is “Yes”, then the value stored in the register for the current year's change in the endowment is set to equal the difference between the remainder portion of the total annual death benefit for the current year and the current year's change in the premium loan balance (step 423), and the value in the register for the premium loan balance at the end of the current year is set to 0 (step 424). On the other hand, if the answer at step 422 is “No”, steps 423 and 424 are skipped and, instead, the value in the register for the premium loan balance at the end of the current year is set to equal the difference between the premium loan balance at the start of the current year and the remainder portion of the total annual death benefit for the current year (step 425).

At step 426, a query is made whether the change in the interest loan balance for the current year is less than or equal to the predetermined portion of the total annual death benefit for the current year. If it is, then the value in the register for the change in the endowment for the current year is incremented by an amount equal to the difference between the predetermined portion of the total annual death benefits for the year and the change in the interest loan balance for the year (step 427), and the value in the register for the interest loan balance at the end of the year is set to 0 (step 428). On the other hand, if the answer to the inquiry at step 426 is “No”, meaning that the cumulative predetermined portions of the death benefits received during the current year do not equal or exceed the change in the interest loan balance, then the value in the register for the out-of-pocket expenses for the current year (OOP^{Year}) is set to equal the difference between the current year's change in the interest loan balance and the predetermined portion of the total annual death benefits for the current year (step 429). Then, at step 430, an inquiry is made regarding whether the value of the endowment at the start of the year is greater than or equal to the out-of-pocket expenses for the year. If so, then money in the endowment will be used to pay the interest loans rather than incurring out-of-pocket expenses. Accordingly, the value stored in the register for endowment existing at the start of the current year is decreased by an amount equal to the out-of-pocket expenses for the year (step 431), the register storing the value of the out-of-pocket expenses for the year is set to 0 (step 432), and the register storing the interest loan balance at the end of the year is set to 0 (step 433). If, however, the answer to the inquiry at step 430 is “No”, then the assets in the endowment will be depleted to pay down the interest loan balance and any remaining interest loan balance will be borne by the tax-exempt organization as out-of-pocket expenses. Accordingly, steps 431-433 are skipped and, instead, the register storing the value of the out-of-pocket expenses for the year is decreased by an amount equal to the value of the endowment at the start of the current year (step 434), the register storing the value of endowment existing at the start of the year is set to 0 (step 435), and the register storing the interest loan balance at the end of the current year is set to 0 (step 436).

At step 437 a calculation is made of the annual return on investment on the updated value of the endowment at the start of the current year. This is done using a random rate of return in the range of 4.5-7.5 percent (which range is based upon historical average returns for low risk investments). Next (step 438), the value stored in the register for the amount of endowment existing at the end of the current year is updated to equal the sum of the endowment value at the start of the current year, the calculated return on that endowment and the current year's change in the endowment.

For the purpose of an analysis of the next year of the iteration, the values in the registers for the next year's start for each of the existing endowment, the premium loan balance and the interest loan balance are set to equal the current year-end values for the endowment, the premium loan balance and the interest loan balance, respectively (step 439).

Finally, at step 440, an analysis of the results for the year is conducted. This step comprises any or all statistical comparisons—between the size of the endowment at the end of the current year (Endow^{YearEnd}) and the out-of-pocket expenses for the current year (OOP^{Year})—that are desired by the tax-exempt organization or any of the other participants in the program. After these comparisons have been completed, the results analysis sequence exits, returning to step 210 of FIG. 3.

Turning now to the flowchart of FIG. 3d, which applies when a secondary interest loan is not used (see step 413 of FIG. 3b), at step 442 the value of the out-of-pocket expenses for the year is set to equal the annual interest on the premium loan balance for the current year (as was calculated at step 412). This is done because, without a secondary interest loan from the premium interest bank 180, all annual interest on the premium loan balance must be borne by the tax-exempt organization out-of-pocket. Following step 442, there is a sequence of steps 443-452 wherein it is determined which of the donor individuals died during the current year, the predetermined portion of the total annual death benefits for the current year is adjusted, and calculations are made of both the current year's change in the endowment and the size of the premium loan balance at the end of the current year. These steps 443-452 are identical to steps 416-425 in FIG. 3c, and therefore will not be described again here in detail. It will be appreciated that these steps assume that the tax-exempt organization uses only the remainder portion of the total annual death benefits (TADBRP) to pay down the premium loan balance, with all of the predetermined portion of the death benefits (TADBPDP) going to the new endowment. Alternatively, the tax-exempt organization could apply both portions of the death benefits to pay down the premium loan balance more rapidly. If this alternative were to be followed, these procedural steps would have to be modified accordingly, pursuant to well-known accounting and code-writing practices.

After those steps are completed, the value in the register for the current year's change in the endowment is incremented by an amount equal to the predetermined portion of the total annual death benefits for the current year (as calculated in step 445). The remaining steps 454-458 are identical to steps 437-441 in FIG. 3c, and therefore will not be described again in detail. It will be appreciated that the 4.5-7.5 percent range of annual return on investment used in step 454 (as well as in step 437) is based upon historically relevant data collected over the past 20 years. If this historically relevant range changes in the future, the program should be modified to use the new relevant range in each of steps 437 and 454.

Upon exiting at step 458, the analysis sequence returns to step 210 of FIG. 3. Once a result analysis has been completed for each year of an iteration of the simulation (i.e., when the answer to the inquiry at step 212 of FIG. 3 is “Yes”), the next step (step 213) is to analyze the total result for the multi-year term of the simulation for the completed iteration. The details of this analysis are illustrated in the flowchart of FIG. 3e. There, a register for the total out-of-pocket expenses for the iteration is initialized to 0 (step 501), and a counter X is set to 1 (step 502). In steps 503-505, the value in the register for the iteration's total out-of-pocket expenses is incremented so as to account for the out-of-pocket expenses that were incurred during each of the T years (preferably 40 years) comprising the current iteration. After that has been done, the total results for the current iteration are analyzed—by statistically comparing the value of the endowment at the end of the iteration to the total out-of-pocket expenses incurred during the iteration—as desired by the tax-exempt organization or any of the other participant in the program (step 506). This analysis sequence then exits, reverting to step 213 of FIG. 3.

At step 214 of FIG. 3, the iteration counter I is incremented by 1. Then, at step 215, the value in the incremented iteration counter is compared to the desired total number of iterations (TI) for the simulation. If the value in the iteration counter does not exceed the desired total number of iterations for this simulation (preferably not less than 10,000 iterations), then the simulation sequence reverts to step 205 of FIG. 3 and another iteration begins.

Once the desired total number of simulation iterations have been performed (i.e., when the answer at step 215 is “Yes”), a calculation is made of the average result for the full simulation (step 216). The details of this calculation are illustrated in the flowchart of FIG. 3f. Specifically, starting at step 601, variable registers for the average final endowment, the average total out-of-pocket expenses, the sum final endowment, and the sum total out-of-pocket expenses, each are initialized to a value of 0. Next (step 602), a counter X is set to a value of 1. In steps 603-606, the values in the variable registers for the sum final endowment and the sum total out-of-pocket expenses are incremented to account for each of the iterations performed in the simulation.

After that has been done (i.e., when the value of the counter X exceeds the desired total number of iterations for the simulation (step 606), calculations are made of the average final endowment and the average total out-of-pocket expenses. The average final endowment is calculated by dividing the value in the register for the sum final endowment by the total number of iterations that were performed (step 607), and the average total out-of-pocket expenses is calculated by dividing the value in the register for the sum total out-of-pocket expenses by the total number of iterations performed (step 608). Finally (at step 609), the average result for the full simulation is studied by statistically comparing the average final endowment to the average total out-of-pocket expenses—in any way desired by the tax-exempt organization or any of the other participants in the program. Following those comparisons, the simulation sequence exits and reverts to step 216 of FIG. 3. The “average” Monte Carlo simulation is thus completed, and stops (step 217).

The simulation embodiment described above with reference to FIGS. 3-3f assumes that living donor individuals do not give gifts to the tax-exempt organization at any time, but the simulation model can be modified, if desired, to allow for the inclusion of gifts from the donor individuals. For example, the model can assume and account for an “average” gift per living donor individual for each year, thus impacting the out-of-pockets costs incurred or, if no out-of-pocket money is needed, the size of the new endowment. It will be appreciated that this modification can be easily accomplished according to well-known accounting and code-writing practices.

As discussed previously, in addition to the “average” simulation described in detail in FIGS. 3-3f, it is often useful to also perform “best case” and “worst case“simulations for the program. These additional simulations can be performed according to the steps of FIGS. 3-3f, with the only difference being the use of modified CSO mortality tables in step 301 of FIG. 3a. For example, in a “best case” simulation, the standard CSO table is modified to assume death ages earlier (e.g., 3.5 years earlier) than normal. And for a “worst case” study, the standard CSO table is modified to assume death ages later (e.g., 3.5 years later) than normal. By performing these additional simulations, the tax-exempt organization and the other participants will be given a much better sense of the potential risks and advantages of the program, and thus should be encouraged to participate.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A method for generating new endowment for a tax-exempt organization, the method comprising the steps of:
identifying a plurality of donor individuals;
purchasing a plurality of life insurance policies, one for each of the donor individuals, each policy having associated therewith an annual premium and a death benefit, wherein the tax-exempt organization is the beneficiary of each policy; and
obtaining a premium loan from a first financing entity to the tax-exempt organization, said premium loan being sufficient to pay the premiums cumulatively due for the plurality of life insurance policies, wherein interest accumulates on the premium loan to create a premium loan balance;
wherein, upon the death of each donor individual, a predetermined priority portion of the death benefit of the respective life insurance policy is used to pay down the premium loan balance, and any remaining amount of said death benefit is accumulated in the new endowment of the tax-exempt organization.

2. The method of claim 1, wherein fifty donor individuals are identified and insured.

3. The method of claim 1, wherein all of the donor individuals initially are in the age range 70-75.

4. The method of claim 1, wherein none of the donor individuals are table rated due to health, occupation or avocation.

5. The method of claim 1, wherein until the premium loan balance is reduced to zero the predetermined priority portion of the death benefit used to pay down the premium loan balance is 100%.

6. The method of claim 1, wherein each life insurance policy also has associated therewith a cash surrender value, the method further comprising the steps of:
determining a collateral amount that is applicable to secure said premium loan balance; and
assigning assets of the tax-exempt organization as collateral against the premium loan balance in favor of the first financing entity, said assignment continuing at least until the cumulative cash surrender value of the policies exceeds the collateral amount.

7. The method of claim 1, wherein the premium loan balance is increased annually at least in an amount necessary to pay the cumulative premiums due to maintain the policies of all surviving donor individuals, and is decreased annually at least in an amount paid down cumulatively from death benefits from the policies of donor individuals deceased during said annual period.

8. The method of claim 1, further comprising the step of:
obtaining an interest loan from a second financing entity to the tax-exempt organization, said interest loan being sufficient to pay the interest accumulated annually on the premium loan, wherein secondary interest accumulates on the interest loan to create an interest loan balance;
wherein, upon the death of each donor individual, a predetermined fixed amount of the death benefit of the respective life insurance policy is used to pay down the interest loan balance, a predetermined priority portion of said death benefit is used to pay down the premium loan balance, and any remaining amount of said death benefit is accumulated in the new endowment of the tax-exempt organization.

9. The method of claim 8, wherein the interest loan balance is paid down to zero each annual period using, in order of priority, death benefits from the policies of donor individuals deceased during said annual period, funds accumulated in the new endowment of the tax-exempt organization, and other assets of the tax-exempt organization.

10. The method of claim 8, wherein the predetermined fixed amount of the death benefit used to pay down the interest loan balance is $75,000.

11. The method of claim 8, wherein until the premium loan balance is reduced to zero the predetermined priority portion of the death benefit used to pay down the premium loan balance is 100% of said benefit remaining after subtraction of the predetermined fixed amount.

12. The method of claim 1, further comprising the step of using a Monte Carlo simulation to predict the growth of new endowment to be generated for the tax-exempt organization.

13. The method of claim 12, wherein the Monte Carlo simulation comprises the operations of:
(a) specifying a fixed term of years for the simulation;
(b) randomly assigning a simulated starting age for each of the plurality of donor individuals for the initial year of the simulation;
(c) randomly determining for each of the plurality of donor individuals a simulated year of death during the term of the simulation, said determination utilizing the randomly assigned simulated starting age and real-world mortality tables;
(d) calculating the growth of the endowment over the term of the simulation, said calculation utilizing at least the randomly determined simulated death year for each donor individual, predetermined premium schedules for the life insurance policies, predetermined death benefit amounts for the life insurance policies, a randomly assigned interest rate applicable to the premium loan balance, the predetermined priority portion of the death benefit to be used to pay down the premium loan balance until reduced to zero, and a randomly assigned annual investment return for the money in the endowment;
(e) repeating operations (b)-(d) a plurality of times; and
(f) determining a predicted average growth result for the endowment over the term of the simulation.

14. The method of claim 13, wherein the randomly assigned interest rate is in the range of 6-9%.

15. The method of claim 13, wherein the randomly assigned annual investment return is in the range of 4.5-7.5%.

16. A Monte Carlo system for predicting the growth results of a program for generating new endowment for a tax-exempt organization, said program including, at least, the purchase of a life insurance policy having an associated death benefit for each of a plurality of donor individuals whereas the tax-exempt organization is the beneficiary of each such policy, the grant of a premium loan from a first financing entity to the tax-exempt organization whereas interest accumulates on the premium loan to create a premium loan balance, and, upon the death of each donor individual, the use of a predetermined priority portion of the death benefit of the respective life insurance policy to pay down the premium loan balance until reduced to zero whereas any remaining money from said death benefit is accumulated in the new endowment of the tax-exempt organization, the Monte Carlo system comprising the operations of:
(a) specifying a fixed term of years for the program;
(b) randomly assigning a starting age to each of the donor individuals for the initial year of the program;
(c) randomly determining for each donor individual a year of death during the term of the program, said determination utilizing the randomly assigned starting age and real-world mortality tables;
(d) calculating the growth result of the endowment over the term of the program, said calculation utilizing at least the randomly determined death year for each donor individual, predetermined premium schedules for the life insurance policies, predetermined death benefit amounts for the life insurance policies, a randomly assigned interest rate applicable to the premium loan balance, the predetermined priority portion of the death benefit to be used to pay down the premium loan balance until reduced to zero, and a randomly assigned annual investment return for the money in the endowment;
(e) repeating operations (b)-(d) a plurality of times; and
(f) determining a predicted average growth result for the endowment over the term of the program.

17. The Monte Carlo system of claim 16, wherein it is assumed there are fifty donor individuals for the program.

18. The Monte Carlo system of claim 16, wherein each of the donor individuals is randomly assigned a starting age in the range 70-75.

19. The Monte Carlo system of claim 16, wherein it is assumed that none of the donor individuals are table rated due to health, occupation or avocation.

20. The Monte Carlo system of claim 16, wherein the randomly assigned interest rate is in the range of 6-9%.

21. The Monte Carlo system of claim 16, wherein the predetermined priority portion of the death benefit used to pay down the premium loan balance until reduced to zero is assumed to be 100%.

22. The Monte Carlo system of claim 16, wherein the randomly assigned annual investment return is in the range of 4.5-7.5%.

23. The Monte Carlo system of claim 16, wherein the fixed term of the program is specified to be forty years.

24. The Monte Carlo system of claim 16, wherein the predetermined death benefit amount assumed for each life insurance policy varies based upon the starting age and the death age of the respective donor individual.

25. The Monte Carlo system of claim 16, wherein operations (b)-(d) are repeated at least 10,000 times.

26. The Monte Carlo system of claim 16, with the program further including the grant of an interest loan from a second financing entity to the tax-exempt organization whereas secondary interest accumulates on the interest loan to create an interest loan balance, such that, upon the death of each donor individual, a predetermined fixed amount of the death benefit of the respective life insurance policy is used to pay down the interest loan balance and a predetermined priority portion of said death benefit is used to pay down the premium loan balance until reduced to zero whereas any remaining money from said death benefit is accumulated in the endowment of the tax-exempt organization, wherein the growth result prediction operation of the Monte Carlo system further utilizes a randomly assigned secondary interest rate applicable to the interest loan balance and the predetermined fixed amount of the death benefit to be used to pay down the interest loan balance.

27. The Monte Carlo system of claim 26, wherein the randomly assigned secondary interest rate is in the range of 6-9%.

28. The Monte Carlo system of claim 26, wherein the predetermined fixed amount of the death benefit used to pay down the interest loan balance is $75,000.

29. The Monte Carlo system of claim 16, wherein the operation of randomly determining a year of death for each donor individual comprises the steps of:
(1) assigning a different random number in the range 0-1000 to each donor individual for the first year of the program;
(2) for each donor individual, comparing their assigned random number to a number of deaths per 1000 people predicted by a real-world mortality table applicable to said individual according to said individual's randomly assigned starting age;
(3) assuming that a donor individual will die during the first year of the program if their assigned random number is less than or equal to the predicted number of deaths;
(4) incrementing by one the year of the program and the age of each surviving donor individual, and assigning a different new random number in the range 0-1000 to each surviving donor individual;
(5) for each surviving donor individual, comparing their new assigned random number to a new number of deaths per 1000 people predicted by a real-world mortality table applicable to said individual according to the individual's incremented age;
(6) assuming that a donor individual will die during the incremented year of the program if their new assigned random number is less than or equal to the new predicted number of deaths; and
(7) repeating steps (4)-(6) until a year of death has been determined for each donor individual.

30. The Monte Carlo system of claim 16, further including a worst-case analysis of the program, said worst-case analysis comprising:
(g) specifying a fixed term of years for the program;
(h) randomly assigning a starting age to each of the donor individuals for the initial year of the program;
(i) randomly determining for each donor individual a year of death during the term of the program, said determination utilizing the randomly assigned starting age and real-world mortality tables adjusted to target an average death age greater by approximately 3.5 years compared to normal mortality;
(j) calculating the growth result of the endowment over the term of the program, said calculation utilizing at least the randomly determined death year for each donor individual, predetermined premium schedules for the life insurance policies, predetermined death benefit amounts for the life insurance policies, a randomly assigned interest rate applicable to the premium loan balance, the predetermined priority portion of the death benefit to be used to pay down the premium loan balance until reduced to zero, and a randomly assigned annual investment return for the money in the endowment;
(k) repeating operations (h)-(j) a plurality of times; and
(l) determining a predicted worst-case growth result for the endowment over the term of the program.

31. The Monte Carlo system of claim 30, wherein operations (h)-(j) are repeated at least 10,000 times.

32. The Monte Carlo system of claim 30, wherein the randomly assigned interest rate is in the range of 6-9%.

33. The Monte Carlo system of claim 30, wherein the randomly assigned annual investment return is in the range of 4.5-7.5%.

34. The Monte Carlo system of claim 16, further including a best-case analysis of the program, said best-case analysis comprising:
(g) specifying a fixed term of years for the program;
(h) randomly assigning a starting age to each of the donor individuals for the initial year of the program;
(i) randomly determining for each donor individual a year of death during the term of the program, said determination utilizing the randomly assigned starting age and real-world mortality tables adjusted to target an average death age shorter by approximately 3.5 years compared to normal mortality;
(j) calculating the growth result of the endowment over the term of the program, said calculation utilizing at least the randomly determined death year for each donor individual, predetermined premium schedules for the life insurance policies, predetermined death benefit amounts for the life insurance policies, a randomly assigned interest rate applicable to the premium loan balance, the predetermined priority portion of the death benefit to be used to pay down the premium loan balance until reduced to zero, and a randomly assigned annual investment return for the money in the endowment;
(k) repeating operations (h)-(j) a plurality of times; and
(l) determining a predicted best-case growth result for the endowment over the term of the program.

35. The Monte Carlo system of claim 34, wherein operations (h)-(j) are repeated at least 10,000 times.

36. The Monte Carlo system of claim 34, wherein the randomly assigned interest rate is in the range of 6-9%.

37. The Monte Carlo system of claim 34, wherein the randomly assigned annual investment return is in the range of 4.5-7.5%.

38. A computer-readable medium having instructions for performing a method for generating endowment for a tax-exempt organization, the method comprising,the steps of:
identifying a plurality of donor individuals;
purchasing a plurality of life insurance policies, one for each of the donor individuals, each policy having associated therewith an annual premium and a death benefit, wherein the tax-exempt organization is the beneficiary of each policy; and
obtaining a premium loan from a first financing entity to the tax-exempt organization, said premium loan being sufficient to pay the premiums cumulatively due for the plurality of life insurance policies, wherein interest accumulates on the premium loan to create a premium loan balance;
wherein, upon the death of each donor individual, a predetermined priority portion of the death benefit of the respective life insurance policy is used to pay down the premium loan balance, and any remaining amount of said death benefit is accumulated in the new endowment of the tax-exempt organization.

39. The computer-readable medium of claim 38, wherein the method further comprises the step of using a Monte Carlo simulation to predict the growth of new endowment to be generated for the tax-exempt organization.

40. A computer-readable medium having instructions for providing a Monte Carlo system for predicting the growth results of a program for generating new endowment for a tax-exempt organization, said program including, at least, the purchase of a life insurance policy having an associated death benefit for each of a plurality of donor individuals whereas the tax-exempt organization is the beneficiary of each such policy, the grant of a premium loan from a first financing entity to the tax-exempt organization whereas interest accumulates on the premium loan to create a premium loan balance, and, upon the death of each donor individual, the use of a predetermined priority portion of the death benefit of the respective life insurance policy to pay down the premium loan balance until reduced to zero whereas any remaining money from said death benefit is accumulated in the new endowment of the tax-exempt organization, the Monte Carlo system comprising the operations of:
(a) specifying a fixed term of years for the program;
(b) randomly assigning a starting age to each of the donor individuals for the initial year of the program;
(c) randomly determining for each donor individual a year of death during the term of the program, said determination utilizing the randomly assigned starting age and real-world mortality tables;
(d) calculating the growth result of the endowment over the term of the program, said calculation utilizing at least the randomly determined death year for each donor individual, predetermined premium schedules for the life insurance policies, predetermined death benefit amounts for the life insurance policies, a randomly assigned interest rate applicable to the premium loan balance, the predetermined priority portion of the death benefit to be used to pay down the premium loan balance until reduced to zero, and a randomly assigned annual investment return for the money in the endowment;
(e) repeating operations (b)-(d) a plurality of times; and
(f) determining a predicted average growth result for the endowment over the term of the program.

41. The computer-readable medium of claim 40, with the program further including the grant of an interest loan from a second financing entity to the tax-exempt organization whereas secondary interest accumulates on the interest loan to create an interest loan balance, such that, upon the death of each donor individual, a predetermined fixed amount of the death benefit of the respective life insurance policy is used to pay down the interest loan balance and a predetermined priority portion of said death benefit is used to pay down the premium loan balance until reduced to zero whereas any remaining money from said death benefit is accumulated in the endowment of the tax-exempt organization, wherein the growth result prediction operation of the Monte Carlo system further utilizes a randomly assigned second interest rate applicable to the interest loan balance and the predetermined fixed amount of the death benefit to be used to pay down the interest loan balance.

42. A method for administering a program for generating new endowment for a tax-exempt organization, the method comprising the steps of:
assisting the tax-exempt organization in identifying a plurality of donor individuals;
assisting the tax-exempt organization in purchasing a plurality of life insurance policies, one for each of the donor individuals, each policy having associated therewith an annual premium and a death benefit, wherein the tax-exempt organization is the beneficiary of each policy;
assisting the tax-exempt organization in obtaining a premium loan from a first financing entity, said premium loan being sufficient to pay the premiums cumulatively due for the plurality of life insurance policies, wherein interest accumulates on the premium loan to create a premium loan balance; and
upon the death of a donor individual, assisting the tax-exempt organization in processing the respective life insurance claim, in using a predetermined priority portion of the death benefit of the respective life insurance policy to pay down the premium loan balance and in accumulating any remaining amount of said death benefit in the new endowment of the tax-exempt organization.

43. The method of claim 42, further comprising the step of using a Monte Carlo simulation to predict the growth of new endowment to be generated for the tax-exempt organization.

44. A method for administering a Monte Carlo simulation for predicting the growth results of a program for generating new endowment for a tax-exempt organization, said program including, at least, the purchase of a life insurance policy having an associated death benefit for each of a plurality of donor individuals whereas the tax-exempt organization is the beneficiary of each such policy, the grant of a premium loan from a first financing entity to the tax-exempt organization whereas interest accumulates on the premium loan to create a premium loan balance, and, upon the death of each donor individual, the use of a predetermined priority portion of the death benefit of the respective life insurance policy to pay down the premium loan balance until reduced to zero whereas any remaining money from said death benefit is accumulated in the new endowment of the tax-exempt organization, the method comprising the steps of:
(a) assuming a fixed term of years for the program;
(b) randomly assigning a starting age to each of the donor individuals for the initial year of the program;
(c) randomly determining for each donor individual a year of death during the term of the program, said determination utilizing the randomly assigned starting age and real-world mortality tables;
(d) calculating the growth result of the endowment over the term of the program, said calculation utilizing at least the randomly determined death year for each donor individual, predetermined premium schedules for the life insurance policies, predetermined death benefit amounts for the life insurance policies, a randomly assigned interest rate applicable to the premium loan balance, the predetermined priority portion of the death benefit to be used to pay down the premium loan balance until reduced to zero, and a randomly assigned annual investment return for the money in the endowment;
(e) repeating operations (b)-(d) a plurality of times;
(f) determining a predicted average growth result for the endowment over the term of the program; and
(g) reporting the predicted average growth result for the endowment to the tax-exempt organization.
